(19) United States
(12) Patent Application Publication
(10) Pub. No.: US 2008/0013721 A1
(43) Pub. Date: Jan. 17, 2008

(54) ASYMMETRIC CRYPTOGRAPHY WITH DISCRETIONARY PRIVATE KEY

(76) Inventor: Jing-Jang HWANG, Kwei-Shan (TW)

Correspondence Address: SINORICA, LLC, 528 FALLSGROVE DRIVE, ROCKVILLE, MD, 20850, US

(21) Appl. No.: 11/564,328

(22) Filed: Nov. 29, 2006

Related U.S. Application Data
(60) Provisional application No. 60/741,245, filed on Nov. 30, 2005.

(51) Int. Cl. H04L 9/00

(52) U.S. Cl. 380/44

(57) ABSTRACT

Several processes and techniques for creating cryptosystems are disclosed. Cryptosystems created accordingly use a personalized secret such as a user-chosen password as a private key and a trio consisting of a first public exponent, a second public exponent, and a modulus as a public key. The public key and the private key form a public/private key pair. Selection of the personalized secret is discretionary and uses no information about the public key.

This Application claims a Priority Filing Date of Nov. 30, 2005 benefited from a previously filed U.S. Provisional Patent Application 60/741,245 entitled “Asymmetric Cryptography with Discretionary Private Key” filed by the same inventor of this Application.

### CROSS REFERENCES TO RELATED US PATENT APPLICATIONS

1. US Patent Application Publication No. 20060083370 “RSA with personalized secret”.
2. U.S. patent application Ser. No. 11/543,875 “User authentication based on asymmetric cryptography utilizing RSA with personalized secret”, filed on Oct. 6, 2006.
3. US Patent Application Publication No. 20060036857, “User authentication by linking randomly-generated authentication secret with personalized secret”.
4. US Patent Application Publication No. 20050081041 “Partition and recovery of a verifiable digital secret”.

### BACKGROUND OF THE INVENTION

1. Field of the Invention

The present invention relates to cryptography. More specifically, the present invention discloses techniques, processes, and systems based on asymmetric cryptography.

2. Description of the Prior Art

Cryptosystems use crypto keys for cryptographic computation. In the cryptosystems based on asymmetric cryptography such as RSA (Rivest, Shamir, and Adleman), crypto keys are generated in pairs of a public key and a private key. The way of using the public/private key pair defines two applications. One application uses the private key as a signature key to produce a digital signature on a digital message and the public key as a verification key for verifying whether a value is a valid digital signature. The other application uses the public key as an encryption key to encrypt a plaintext into a cipher and the private key as a decryption key to decrypt the cipher back to the plaintext.

Users who are a signatory performing digital signature must keep their signature private key confidential. Also, users who are a cipher receiver must keep their decryption private key confidential. The private key is a secret. Disclosure of the public key must not reveal the secrecy of the private key, though the private key has a dependence on the public key. Due to this secrecy requirement, computational intractability of deriving the private key from the public key is vital to the security of asymmetric cryptosystems.

In the RSA scheme, computation is carried out with modular arithmetic using the product of two primes as the modulus. The computational intractability of deriving the private key from the pairing public key rests in part on the lack of an efficient algorithm for factoring the product back to the two primes. Nevertheless, the private key is not independent of the public key owing to their relationship with the two secret primes. This relationship prohibits the private key from being chosen by a user at the discretion of the user.

Asymmetric cryptosystems have been around for a long time, but have not been as widely applied as perceived. For example, user login with password where no public/private key pairs are used remains common. One reason for low expectations is the inflexibility on selection of the secret private key.

Thus, there exists a need to create such flexibility into asymmetric cryptography.

The following describes the basic background for the RSA cryptosystem.

The RSA cryptosystem is described in U.S. Pat. No. 4,405,823 and in the paper: Rivest, Shamir, and Adleman, “A Method for Obtaining Digital Signatures and Public-Key Cryptosystems,” Communications of the ACM, vol. 21 (1978), pp. 120-126. Several standards have been developed for teaching this asymmetric cryptography, including PKCS #1:RSA Cryptography Standard, November 1993 (v. 1.5) & June 2002 (v. 2.1) and IEEE Std 1363-2000: IEEE Standard Specification for Public-Key Cryptography, which are respectively available at the web site of RSA Laboratories and that of IEEE. These standards include descriptions on key generation, encryption, decryption, signature generation, signature verification, and other related techniques.

RSA computations always involve modular arithmetic. The definition on modular arithmetic is given here. If x and y are integers, then x is said to be congruent to y modulo a positive integer z, written x≡y mod z, if z divides (x−y). The positive integer z is called the modulus of the congruence.

The RSA key generation process recommended in PKCS#1 v.1.5 is summarized below:

(1) A positive integer e is chosen as the public exponent.

(2) Two distinct odd primes p and q are randomly selected such that e is relatively prime to both p−1 and q−1.

(3) The modulus is the product n=p×q.

(4) The private exponent d is chosen such that both p−1 and q−1 divide d×e−1.

The RSA public exponent e and modulus n are used to encrypt a plaintext integer m, assumed less than n, to get a cipher integer c by computing c≡m^{e} mod n. The private exponent d and modulus n are used to decrypt the cipher c back to the plaintext m by computing m≡c^{d} mod n.

In certain cryptosystems such as those built accordingly to the SSL/TLS (Secure Sockets Layer/Transport Layer Security) protocols, encryption with RSA is often combined with encryption using symmetric cryptography, creating a hybrid cryptosystem. In such a hybrid cryptosystem, one side of the communication encrypts a randomly-generated secret number with an RSA public key while the other side receives and decrypts the encrypted secret number with a pairing RSA private key; subsequently, both sides use the same secret as a symmetric crypto key for confidential communications. The symmetric crypto key exchanged in this way is called a session key. For details, refer to RFC 2246 and other related documents at the web site of the Internet Engineering Task Force.

The RSA private exponent d and modulus n are used to produce a digital signature. First, a digital message M is processed by a selected collision-resistant hash function to produce a number as a digest on M, expressed as hash(M). Next, the digital signature on M, expressed as signature(M), is obtained by computing signature(M)≡(hash(M))^{d} mod n.

The RSA public exponent e and modulus n are used to validate a value as being a valid digital signature. Suppose that M∥SGN is received by a verifier, where M represents a digital message and SGN represents a number that is attached as a digital signature on M. The verifier first computes hash(M) using the selected collision-resistant hash function, and decrypts SGN with the public key (n, e) by computing SGN^{e} mod n; next, the verifier compares hash(M) with the decryption result. If the comparison yields an equal, then SGN is a valid digital signature.

Hash functions are used in producing a digital signature. Hash functions are deterministic, meaning that the output is completely determined by the input. The hash function used in digital signature should generally be collision-resistant. This means that it is infeasible to find two distinct inputs that could produce one same output of the hash function. Collision-resistant hash functions also have the desired property of being one-way; this means that given an output, it is infeasible to find an input whose hash is the specified output. In addition, the hash function should be a mask generation function with pseudorandom output: Given one part of the output but not the input, it should be infeasible to predict another part of the output. Six hash functions possessing these properties are suggested for various implementations in PKCS #1 v.2.1: MD2, MD5, SHA-1, SHA-256, SHA-384, and SHA-512.

### SUMMARY OF THE INVENTION

As described above, the conventional asymmetric cryptography is inflexible in the sense that the user is not allowed to select the private key at his/her discretion. To overcome this disadvantage and to achieve other advantages, the present invention provides several processes for creating cryptosystems based on the concept of asymmetric cryptography. The functions performed by these processes comprise crypto-key generation, digital signature computation, digital signature validation, message encryption, cipher decryption, and private-key input validation.

The core of these processes is the one for crypto-key generation, which produces crypto keys in pairs of a private key and a public key. A unique feature of this process is the way by which the key pair is produced. Selection of the private key is discretionary, i.e. a discretionary choice by its user, and uses no information on the public key. After the selection, the private key is used as an input in a public-key generation process to produce a first public exponent, a second public exponent, and a modulus as the public key.

The reason for naming the three components of the public key as such will become clear when the processes for digital signature computation and others are described in the following specification.

The public key generation process comprises using a transformation, which is a collision-resistant function, to transform the private key into a temporary secret, selecting a positive integer as the first public exponent, and using the temporary secret and the first public exponent in a process to produce the second public exponent and the modulus.

User-chosen passwords are an exemplary selection of the private key. The public-key generation process further comprises using a password and a positive integer as input to produce a second public exponent and a modulus. The positive integer is included in the public-key as the first public exponent. The public key consists of two additional components: the second public exponent and the modulus.

The public-key generation process has the capability of accepting a same selection as the private key and a different selection as the first public exponent to produce a different second public exponent and a different modulus. This feature is useful for user authentication in a network having a plurality of computer systems. Users are allowed to register different public keys with different systems but use one identical private key such as a same password to access each of the systems.

To access a computer system, users often need to provide a password input for user authentication. In conventional systems, the password input is verified against a derivative of a correct password such as a hash value of the password. This way of input validation is changed in systems created for user authentication according to the present invention. In such systems, the password input is a private-key input. Password input validation is carried out through a process for private-key input validation which utilizes the pairing public key as the verification key. One advantage for changing the conventional way of password input validation is that a leak of the public key is much less of a security concern.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a diagram illustrating the sequence in which a private key and a public key are generated as a public/private key pair according to an embodiment of the present invention;

FIG. 2 is a flowchart illustrating a process for generating a public key given a pairing private key as input according to an embodiment of the present invention;

FIG. 3 is a flowchart illustrating a process for producing a digital signature on a digital message according to an embodiment of the present invention;

FIG. 4 is a flowchart illustrating a process for validating an integer as being a valid digital signature according to an embodiment of the present invention; and

FIG. 5 is a flowchart illustrating a process for validating a private-key input as being a valid private key according to an embodiment of the present invention.

### DETAILED DESCRIPTION

Reference will now be made in detail to the preferred embodiments of the present invention, examples of which are illustrated in the accompanying drawings. Wherever possible, the same reference numbers are used in the drawings and the description to refer to the same or like parts.

The present invention discloses several processes for creating cryptosystems including crypto-key generation, digital signature computation, digital signature validation, private-key input validation, message encryption, and cipher decryption.

Crypto-Key Generation

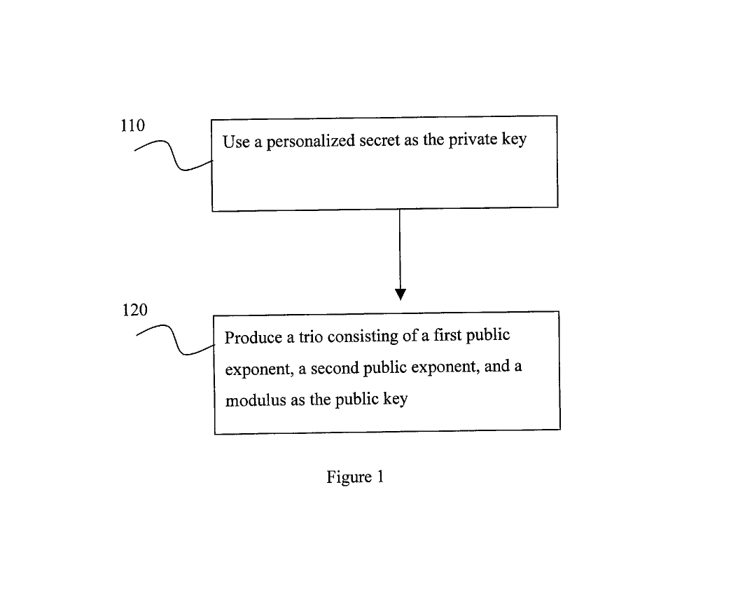

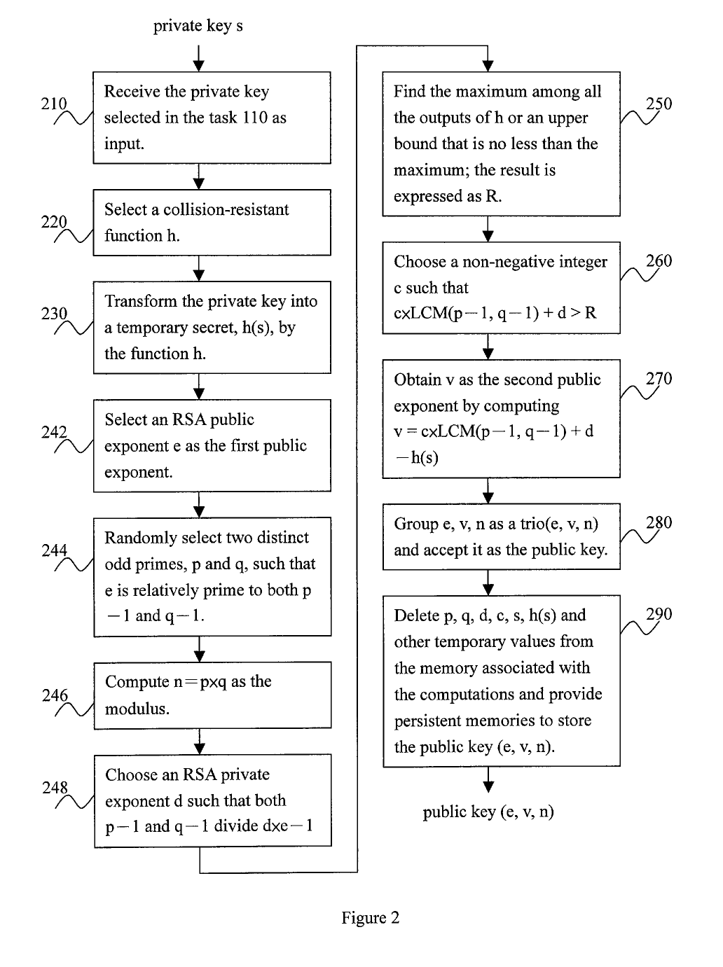

Refer to FIG. 1, which is a diagram illustrating the sequence in which a private key and a public key are generated as a public/private key pair according to an embodiment of the present invention, and to FIG. 2, which is a flowchart illustrating a process for generating a public key given a pairing private key as input according to an embodiment of the present invention.

As illustrated in FIG. 1, this crypto-key generation process produces a private key and a public key in sequence. The result is a public/private key pair that can be used in either one of a first application where the private key is used in digital signature computation while the public key is used in digital signature validation and a second application where the public key is used in message encryption while the private key is used in cipher decryption.

The first task 110 in FIG. 1 allows a user to select a personalized secret such as a user-chosen password as the private key. Selection of the secret is discretionary. The selection is carried out prior to generating the public key and uses no information about the public key.

The second task 120 in FIG. 1 uses the private key as input in a public-key generation process to produce a trio consisting of a first public exponent, a second public exponent, and a modulus as the public key.

As illustrated in FIG. 2, the public-key generation process for Task 120 comprises the following steps:

Step 210: Receive the private key, expressed as s, selected in Task 110 as input.

Step 220: Select a collision-resistant function that produces a non-negative integer. The function is expressed as h. It is collision resistant, meaning it is very unlikely if not impossible to find two distinct inputs to produce one same output.

Step 230: Transform the private key into a temporary secret, expressed as h(s), by the function h obtained in Step 220.

Step 242: Select an RSA public exponent, a positive integer expressed as e, as the first public exponent.

Step 244: Randomly select two distinct odd primes p and q such that e is relatively prime to p−1 and q−1.

Step 246: Compute n=p×q as the modulus.

Step 248: Choose an RSA private exponent d such that p−1 and q−1 divide d×e−1.

Step 250: Find the maximum among all the outputs of the function h obtained in Step 220 or a value greater than the maximum if the maximum is unavailable. The result is expressed as R.

Step 260: Choose a non-negative integer c such that c×LCM(p−1, q−1)+d is greater than R obtained in Step 250.

Step 270: Obtain v as the second public exponent by computing v=c×LCM(p−1, q−1)+d−h(s).

Step 280: Group the first public exponent e, the second public exponent v, and the modulus n as a trio (e, v, n) and accept it as the public key.

Step 290: Delete p, q, d, c, the private key s, the temporary secret h(s) and other temporary values from the memory associated with the computations and provide persistent memories to store the public key (e, v, n).

The part performed by Steps 242, 244, 246, and 248 together is a modification on a standard RSA crypto-key generation process as that described in PKCS #1 (RSA Cryptography Standard, June 2002 (v. 2.1) by RSA Laboratories) or that described in IEEE Std 1363-2000 (IEEE Standard Specification for Public-Key Cryptography).

In FIG. 2, the Steps 244-290 together can be considered as a process that uses the temporary secret and the first public exponent as input to produce the second public exponent and the modulus.

User-chosen passwords are an exemplary private key. Thus, “private key” in the above descriptions of FIG. 2 can be substituted with “password”.

The user may carry out this public-key generation process on a user processor.

Digital Signature Computation

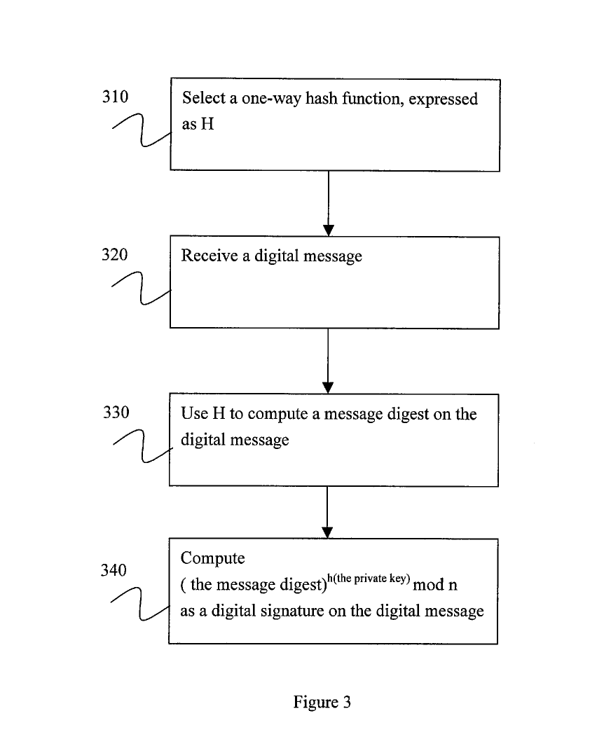

Refer to FIG. 3, which is a flowchart illustrating a process for producing a digital signature on a digital message according to an embodiment of the present invention.

The exemplary process illustrated in FIG. 3 is performed on a user processor. In Step 310, the user processor selects a one-way hash function H. In Step 320, the user processor receives a digital message M. In Step 330, the user processor computes H(M), a positive integer, as a message digest on M. In Step 340, the user processor computes (H(M))^{h(s)} mod n as a digital signature on M, where s the private key and h is the function selected in Step 220.

The two functions h and H are also used in the processes of signature validation and private-key input validation as described below. The two functions h and H may be either different or the same.

Digital Signature Validation

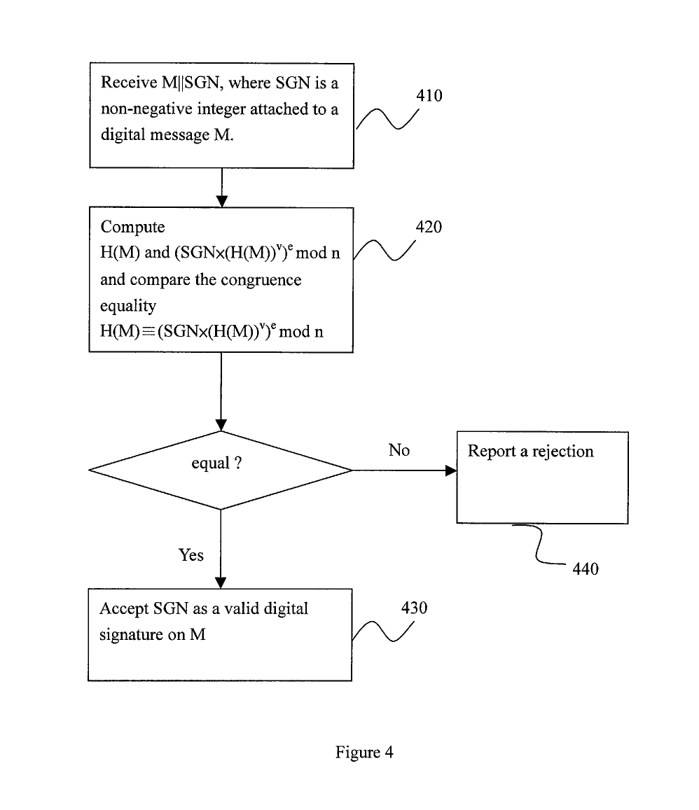

Refer to FIG. 4, which is a flowchart illustrating a process for validating an integer as being a valid digital signature according to an embodiment of the present invention.

The exemplary process illustrated in FIG. 4 is performed on a processor. In Step 410, the processor receives M ∥ SGN, in which SGN is a non-negative integer attached to M as a signature on M. In Step 420, the processor computes H(M) and (SGN×(H(M))^{v})^{e} mod n and subsequently compares the congruence equality: H(M)≡(SGN×(H(M))^{v})^{e} mod n. If equal then SGN is accepted as being a valid digital signature on M in Step 430; otherwise, SGN is invalid and is rejected in Step 440. In this validation, the public key (e, v, n) and the function H selected in Step 310 are used.

Private-Key Input Validation

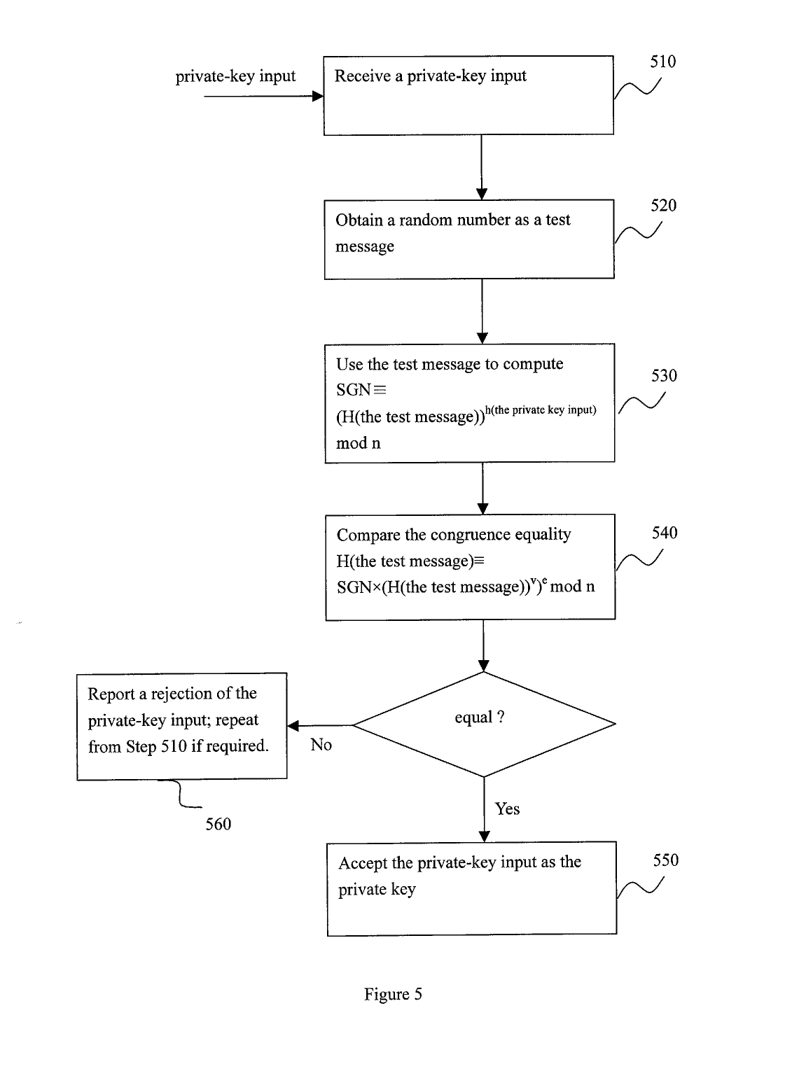

Refer to FIG. 5, which is a flowchart illustrating a process for validating a private-key input as being a valid private key according to an embodiment of the present invention.

To produce a valid digital signature, the user must ensure correctness of the private-key input. The pairing public key can be used in this validation process as illustrated in FIG. 5.

It is assumed that the private-key input validation takes place on a user processor where the pairing public key (e, v, n) is available. In Step 510, the user processor receives a private-key input. In Step 520, the user processor obtains a random number as a test message. In Step 530, the user processor computes a message digest on the test message, H(the test message), and subsequently computes SGN≡(H(the test message))^{h(the private key input)} mod n, where H and h are as defined earlier. In Step 540, the user processor computes (SGN×(H(the test message))^{v})^{e} mod n and subsequently compare the congruence equality: H(the test message)≡(SGN×(H(the test message))^{v})^{e} mod n. If the congruence equality in Step 540 holds then the private-key input is accepted as valid in Step 550; otherwise, the private-key input is rejected in Step 560 and the process is repeated from Step 510 when necessary.

Message Encryption and Cipher Decryption

Given a public key (e, v, n) and a non-negative integer m less than the modulus n, the computations of Cipher₁≡m^{e} mod n and Cipher₂≡Cipher₁^{v} mod n result in a pair (Cipher₁, Cipher₂). This pair is considered as a cipher on M.

Given a cipher expressed as (Cipher₁, Cipher₂), a private key and its paring public key (e, v, n), the process decrypting the cipher back to a plaintext comprises the following steps: (1) receive a private-key input and validate it as a valid private key via a process as that illustrated in FIG. 5, and (2) obtain the plaintext m by computing m≡(Cipher₁)^{h(the private-key input)}×Cipher₂ mod n.

Notation

The following defines the notations, which are used in the proof established below.

s: private key;

(e, v, n): public key;

e: first public exponent;

v: second public exponent;

n: modulus;

h: collision-resistant function, selected in Step 220;

H: one-way hash function, selected in Step 310;

d: RSA private key, which is the result of Step 248;

p and q: which are the two primes selected in Step 244;

LCM: Least Common Multiple;

R: result of Step 250;

φ: Euler's φ function.

The Underlining Mathematics

The following proof establishes two properties for the cryptography described in the present invention: (1) verifiability of digital signature, and (2) recoverability of encryption.

Step 270 implies:
d≡h(s)+v mod LCM(p−1, q−1). Equation (I)

Steps 242, 244, 246, and 248 together perform an RSA key generation process and thereby establish the basic relationship between d and e:
1≡d×e mod LCM(p−1, q−1). Equation (II)

By the same technique adopted in the original RSA paper, the following equation is established:
H(M)≡H(M)^{1+wLCM(p-1, q-1)} mod n. Equation (III)

In Equation (III), M denotes an arbitrary message and w represents a non-negative integer.

By utilizing Equations (I), (II), and (III), we can prove that H(M)≡(((H(M))^{h(s)} mod n)×(H(M))^{v})^{e} mod n. This implies that the digital signature, obtained by computing (H(M))^{h(s)} mod n, can be validated as being valid by using the corresponding public key (e, v, n) in the validation computation.

In the same way, we can prove that m≡((Cipher₁)^{h(s)}×Cipher₂) mod n given Cipher₁≡m^{e} mod n and Cipher₂≡Cipher₁^{v} mod n. This proves that the cipher (Cipher₁, Cipher₂), produced by using the public key (e, v, n) in the encryption computation, can be recovered by using the pairing private key s in the decryption computation.

On the Security Aspect

Computational intractability of deriving the private key from the public key is most vital to the security of asymmetric cryptosystems. The public key is a trio (v, e, n) now. Will the disclosure of the trio help crack the private key s or its derivative h(s)?

According to FIG. 1, selection of the private key s uses no information on the public key (e, v, n). According to Steps 242, 244, and 246, generation of e and n uses no information on the private key s. Therefore, disclosure of e, n, or both leaks no information about s and h(s).

Also, deriving d from e and n is computationally intractable, provided that d, e, and n are generated, in Steps 242, 244, 246, and 248 of FIG. 2, according to the acceptable practices in the RSA crypto-key generation.

The challenge here is this question: Will the disclosure of v lead to crack any secret among the private key s, its derivative h(s), and the “deleted” RSA private key d?

To answer this challenging question, the notion “equivalent keys” is first defined.

In the conventional RSA, two private keys are equivalent if each of them is paired with one same public key to form a valid public/private key pair. Two private keys are equivalent implies that digital signatures produced with either one can be validated using the same public key. In a similar way, the notion that two public keys are equivalent can be defined. Given ((e, n), d) as a conventional RSA public/private key pair generated with two primes p and q, it has been known that (1) d and d+LCM(p−1, q−1) are equivalent private keys, and (2) (e, n) and (e+LCM(p−1, q−1), n) are equivalent public keys.

The notion on “equivalence” can also be defined with modifications for the cryptography described in the present invention. Given the notations as defined, h(s) and h(s)+LCM(p−1, q−1) are considered equivalent because SGN₁≡(H(M))^{h(s)} mod n and SGN₂≡(H(M))^{h(s)+LCM(p-1, q-1)} mod n are both a valid digital signature. Given the same notations, (v, e, n) and (v+LCM(p−1, q−1), e, n) are two equivalent public keys. In this cryptography, the RSA private key d, produced in Step 248 of FIG. 2, is a temporary value; nevertheless, d and d+LCM(p−1, q−1) are considered equivalent because they yield equivalent public-key trios.

Based on the notion on equivalence, the equation v=c×LCM(p−1, q−1)+d−h(s), which is used in Step 270, can be replaced with a more relaxed equation:
d≡h(s)+v mod LCM(p−1, q−1) Equation (I).

Equation (I) is more relaxed, meaning that it is satisfied by d, h(s), and v as well as by their equivalents.

In the conventional RSA, the existence of two distinct equivalent keys reveals no discernible clues to crack the private key or its equivalents from the disclosure of the public key if the public/private key pair is generated according to the acceptable practices in RSA. One of the practices is that LCM(p−1, q−1) must be large enough and made unavailable. In the present invention, it is also assume that LCM(p−1, q−1) is large and made unavailable such that the temporary RSA private key d is very unlikely to crack from the disclosure of e and n.

According to the same reason for ignoring the existence of distinct equivalent keys in the conventional RSA, it is allowed, in this cryptography, to restrict h(s) and d to values that are less than LCM(p−1, q−1). With this restriction, Equation (I) implies that the mapping from an output of h to a value instance of v is one-to-one. As such, disclosure of v does not reduce the space consisting of all possible values of h(s) when the three elements d, p, and q are unknown. With the same restriction, Equation (I) implies that the mapping from a value instance of d to a value instance of v is one-to-one. As such, disclosure of v does not help guess d when the three elements h(s), p, and q are unknown.

The next question to ask is this: Is it easier to crack s than to crack h(s)?

Given h being collision-resistant, cracking s is, in general, not noticeably easier than cracking h(s). In certain circumstances, s may be restricted to smaller domains; for example, s can be a user-chosen password. Such information may lure attackers to crack s with specific skills like dictionary attacks.

As described below, the present invention comprises certain techniques to harden password dictionary attacks.

Assume that the private key is a password. Based on the technique of private-key input validation as described earlier, the password can be non-existent in any device; for the same reason, none of the password's hash values or similar derivatives must be kept for input validation. A password input is indirectly validated via validating a digital signature produced with the password input. This design strengthens the protection of the password.

Similar derivatives of the password herein are single-input derivatives of the password, meaning an output of a single-input transformation that receives the password as the sole input. As designed, the computation for input validation uses the public-key (e, v, n), in which e and n are independent of the password but v is indeed a derivative of the password. Owing to v=c×LCM(p−1, q−1)+d−h(the password), the derivation of v uses other inputs independent of the password. Precisely speaking, this derivation is not a single-input derivation.

The relationship between the password and the second public exponent v, established by Equation I, becomes intractable upon destroying the secrets p, q, d, c, s, and h(s) in Step 290.

Thus, password guessing is hardened.

Advantages

The major benefit of the present asymmetric cryptography is flexibility: allowing a user to select the private key at his/her discretion. This feature would certainly create new application scenarios for asymmetric cryptography. For example, such flexibility allows a user to select the same private key but select a different first public exponent in Step 242 to produce a different modulus in Step 246 and a different second public exponent in Step 270. Given such, the user is able to register different public keys with different systems while using one identical private key such as a same password to access each of the systems.

Replacing LCM with Euler's φ Function

In the descriptions above, LCM(p−1, q−1) can be replaced with φ(p×q). The proofs remain true, because φ(p×q) is a multiple of LCM(p−1, q−1).

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of creating a cryptosystem based on asymmetric cryptography, comprising:
allowing a user to discretionarily select a private key;
using the private key as an input in a public-key generation process to produce a public key; and
using the private key and the public key in either one of a first application where the private key is used in digital signature computation while the public key is used in digital signature validation or a second application where the public key is used in message encryption while the private key is used in cipher decryption.

2. The method of claim 1 wherein selection of the private key uses no information about the public key.

3. The method of claim 1 wherein the private key is a password.

4. The method of claim 1 wherein the public-key generation process produces a first public exponent, a second public exponent, and a modulus as the public key.

5. The method of claim 4 wherein the public-key generation process comprises:
transforming the private key into a temporary secret, which is a positive integer, by a collision-resistant transformation;
selecting a positive integer as the first public exponent; and
using the temporary secret and the first public exponent to produce the second public exponent and the modulus.

6. The method of claim 5 further comprising:
using the private key and a different first public exponent to produce a different second public exponent and a different modulus; and
using the different first public exponent, second public exponent, and modulus to form a different public key.

7. The method of claim 1 further comprising:
using a first process for digital signature computation; and
using a second process for digital signature validation.

8. The method of claim 1 further comprising:
using a first process for message encryption; and
using a second process for cipher decryption.

9. The method of claim 1 further comprising validating a private-key input as the private key.

10. A method of creating a cryptosystem based on asymmetric cryptography, comprising:
using a password in producing a trio consisting of a first public exponent, a second public exponent, and a modulus;
using the password as a private key and the trio as a public key; and
using the private key and the public key in either one of a first application where the private key is used in digital signature computation while the public key is used in digital signature validation or a second application where the public key is used in message encryption while the private key is used in cipher decryption.

11. The method of claim 10 further comprising
using a first process for digital signature computation;
using a second process for digital signature validation;
using a third process for message encryption; and
using a fourth process for cipher decryption.

12. The method of claim 10 further comprising using the password and a positive integer to produce the first public exponent, second public exponent, and modulus.

13. The method of claim 10 further comprising validating a password input as the password.

14. A cryptosystem based on asymmetric cryptography, comprising:
means for using a private key in producing a public key; and
means for using the private key and the public key in either one of a first application where the private key is used in digital signature computation while the public key is used in digital signature validation or a second application where the public key is used in message encryption while the private key is used in cipher decryption.

15. The cryptosystem of claim 14 further comprising:
means for transforming the private key into a temporary secret, which is a positive integer, by a collision-resistant transformation;
means for selecting a positive integer as the first public exponent; and
means for using the temporary secret and the first public exponent to produce the second public exponent and the modulus.

16. The cryptosystem of claim 14 further comprising
means for digital signature computation;
means for digital signature validation;
means for message encryption;
means for cipher decryption; and
means for validating a private-key input as the private key.

17. The cryptosystem of claim 14 further comprising means for allowing a user to discretionarily select the private key.
